(19) United States
(12) Patent Application Publication
(10) Pub. No.: US 2012/0203609 A1
(43) Pub. Date: Aug. 9, 2012

(54) SYSTEM AND METHOD FOR A RETAIL AND INVESTMENT APPLICATION

(75) Inventor: DMITRY LYUBARSKY, WATERTOWN, MA (US)

(73) Assignee: HUMANBOOK, INC, WELLESLEY HILLS, MA (US)

(21) Appl. No.: 13/368,805

(22) Filed: Feb. 8, 2012

Related U.S. Application Data
(60) Provisional application No. 61/441,172, filed on Feb. 9, 2011.

(51) Int. Cl. G06Q 30/00; G06Q 40/06; G06Q 30/02

(52) U.S. Cl. 705/14.18; 705/26.1; 705/14.17

(57) ABSTRACT

A system for an Internet-based retail and investment platform includes a bank application and a retail market platform. All transactions between the bank application and the retail market platform utilize a system specific currency, which is issued by the bank. Customers open bank accounts with funds in the system specific currency and make payments for the purchase of goods and services offered through the retail market platform with the system specific currency. Goods and services are offered at a discounted price by the merchants that subscribe to the retail merchant. The discount is based on the difference between retail price and wholesale price. In return for the discount, the merchants receive access to value-added services. The discounts generate profits that are distributed to the system users as dividends.

### CROSS REFERENCE TO RELATED CO-PENDING APPLICATIONS

This application claims the benefit of U.S. provisional application Ser. No. 61/441,172 filed on Feb. 9, 2011 and entitled SYSTEM AND METHOD FOR A RETAIL AND INVESTMENT APPLICATION which is commonly assigned and the contents of which are expressly incorporated herein by reference.

### FIELD OF THE INVENTION

The present invention relates to a system and a method for a retail and investment application and in particular to a combined web-based retail and investment application that utilizes its own system currency.

### BACKGROUND OF THE INVENTION

Retail refers to the exchange of goods and services between a merchant/vendor and a customer/consumer. Typically the consumer pays with government issued currencies for the purchase of goods and/or services and the merchant provides the goods and/or services. Retail may be performed in physical locations/stores or in virtual web-based locations/websites. Currently, there are several web-based retail systems, such as Amazon.com, eBay.com, buy.com, among others. Most of these online retailers provide goods and/or services to consumers and receive payments from the consumers via credit cards or online accounts. These payments are made with government issued currencies and are processed via payment processor servers. Web-based retail system address markets and consumers worldwide and across several countries. Currently, credit card companies provide currency conversion services to consumers for the payment of goods or services purchased online from a merchant located in a different country than the country of the consumer. These currency conversion services add currency conversion fees to the purchase price which results in higher prices for the purchased goods and services. Furthermore, the currency exchange rates that are provided by the credit card companies are not the most advantageous for the consumer and they also increase the price of the purchased goods and services.

Investment refer to the process of putting funds into an account or a venture with the expectation that it will provide a return higher than the initial invested principal. There are several investment systems that invest funds in various sectors, such as savings accounts, stocks, bonds, currency, real estate, and futures, among others. There are also several web-based investment systems that provide the above mentioned investment offerings in an online web-based environment, such as e-trade.com, forex.com, ing.com, scottrade.com, vanguard.com, among others.

Currently, there is no system that provides both an online retail system and an online investment system.

### SUMMARY OF THE INVENTION

In general, in one aspect, the invention features an online retail and investment system that includes a computing system, a bank application configured to run in the computing system and to be accessed via a network, a retail market application configured to run in the computing system and to be accessed via the network and an open market currency (OMC). The OMC is issued by the bank application and is used for making payments for purchase transactions within the retail market application. Customers access the bank application over a network connection and open bank accounts and subsequently the customers purchase funds in the open market currency and deposit the OMC funds in their corresponding bank accounts. Merchants access the retail market application via a network connection and open merchant accounts and subsequently offer their goods and services for sale to customers through the retail market application. The customers purchase goods and services offered by the merchants through the retail market application and pay for the purchased goods and services with OMC funds from their corresponding bank accounts. The merchants offer their goods and services to the customer through the retail market application at a discount. A first portion of the discount is passed to the customers at the time of the purchase transaction and a second portion of the discount is retained by the system as a profit. Alternatively, the merchants pay a bonus for selling their goods and services to the customer through the retail market application and the bonus is retained by the system as a profit.

Implementations of this aspect of the invention may include one or more of the following features. The system profit is accumulated and is distributed as a dividend to the customers, outside system investors, and system participants. The system profit is distributed as a dividend based on performance metrics. The performance metrics are configured to promote growth of the total volume of the purchase transactions and include one or more of number of purchases within a given period of time, length of system membership, number of new customer referrals, number of new customer acquisitions, number of new merchant acquisitions, number of fund shares, or percentage of reinvestment of dividend. The system participants may be brokers for customers, brokers for merchants, application developers, system designers and operating bank personnel. The bank application is configured to maintain all customer data associated with the customer bank accounts and to keep track of all data associated with purchases made by each customer within the retail market application and the corresponding discount profits associated with these purchases and to maintain records for all deposits, withdrawals, transfers and wire transactions for each customer bank account. The bank application is configured to maintain all merchant data associated with the merchant accounts and to keep track of all merchant discounts, all sales transacted and all profits generated within the retail market application. The system may further include customer brokers and merchant brokers. The customer brokers open customer account within the bank application and the merchant brokers open merchant accounts in the retail market application. The bank application further includes broker accounts and is configured to maintain all broker data associated with the broker accounts and to keep track of all new customer accounts and new merchant accounts generated by each broker. The system further includes a database and the database stores the customer data, the merchant data and the broker data. The bank application is configured to calculate the dividend, to determine eligibility and to distribute the calculated dividend to each eligible customer, broker, outside system investors, and system participants. The bank application is configured to issue loans to each eligible customer, broker, outside system investors, and system participants, based on the accumulated profits. The system further includes a retail market platforms and the retail market platform includes the retail market application, individual merchant applications and common applications. The individual merchant applications are configured to present product offerings for individual merchants and the common applications are configured to manage, aggregate and promote the individual merchant applications. The common applications include one or more of browsing, searching, advertising, grouping, comparing of product offerings, product reviews and recommendations, collaborative recommendations and suggestions, network marketing tools or hot product presentation. The merchants receive value added services in return for the provided discount. The value added services include one or more of grouping of buyers, consumption planning and forecast, new market discovery, sales management, production planning or collaborative recommendations.

In general, in another aspect, the invention features a method for providing online retail and investment. The method includes providing a computing system, providing a bank application configured to run in the computing system and to be accessed via a network, providing a retail market application configured to run in the computing system and to be accessed via the network and providing an open market currency (OMC). The OMC is issued by the bank application and is used for making payments for purchase transactions within the retail market application. Customers access the bank application over a network connection and open bank accounts and subsequently the customers purchase funds in the open market currency and deposit the OMC funds in their corresponding bank accounts. Merchants access the retail market application via a network connection and open merchant accounts and subsequently offer their goods and services for sale to customers through the retail market application. The customers purchase goods and services offered by the merchants through the retail market application and pay for the purchased goods and services with OMC funds from their corresponding bank accounts. The merchants offer their goods and services to the customer through the retail market application at a discount. A first portion of the discount is passed to the customers at the time of the purchase transaction and a second portion of the discount is retained by the system as a profit. Alternatively, the merchants pay a bonus for selling their goods and services to the customer through the retail market application and the bonus is retained by the system as a profit.

The details of one or more embodiments of the invention are set forth in the accompanying drawings and description below. Other features, objects, and advantages of the invention will be apparent from the following description of the preferred embodiments, the drawings, and from the claims.

### BRIEF DESCRIPTION OF THE DRAWINGS

FIG. 1 is an overview diagram of a web-based retail platform and investment system, according to this invention;

FIG. 2 is a schematic diagram of a product purchase process utilizing the system of FIG. 1;

FIG. 3A is a process flow diagram of a product purchase utilizing the system of FIG. 1;

FIG. 3B is a process flow diagram of another embodiment of the product purchase utilizing the system of FIG. 1;

FIG. 4 is a block diagram of the bank application of FIG. 1;

FIG. 5 is a block diagram of the retail market platform of FIG. 1; and

FIG. 6 is a computer system used for running the methods of this invention.

### DETAILED DESCRIPTION OF THE INVENTION

A system for an Internet-based combined retail and investment platform includes a bank application and a retail market platform. All transactions between the bank application and the retail market platform utilize a system specific currency, which is issued by a bank associated with the system. The system specific currency is referred to as open market currency (OMC) in this document. Customers open bank accounts with funds in open market currency and make payments for the purchase of goods and services offered through the retail market platform with the open market currency. Goods and services are offered at a discounted price through the retail market platform. The discount is based on the difference between retail price and wholesale price offered to the system by the merchants. The discount is also based on the elimination of currency conversion fees and variable foreign exchange rates. In return for the offered discounts, the merchants receive access to value-added services. These value-added services are provided by the system, and include access to group of buyers, consumption planning and forecast, new market discovery, interest discovery, sales management, production planning, collaborative recommendations, and production recommendations, among others. The discount is divided between the customer and the system at the time of the purchase. The customer's share is received as a discount in the price of the purchased merchandise. The system's portion of the discount is collected by the bank as system profit and a portion of all system profits is later distributed to all system users as dividend based on performance metrics. A portion of the system's funds is invested in derivative products and a retail fund. The profits from these investments are also distributed to the system users based on performance metrics. The system also provides for retail transactions with merchants outside of the retail platform. The system is applicable to all B2C, B2B, C2C applications, games, social networking websites, and other consuming online or offline businesses.

The system also provides a new currency and a mechanism for the new currency to appreciate. The currency appreciation mechanism is based on the retail margin. The currency appreciation generates dividends that are distributed to all system users. The new system is applicable to commercial websites, applications, games, and other online and offline business.

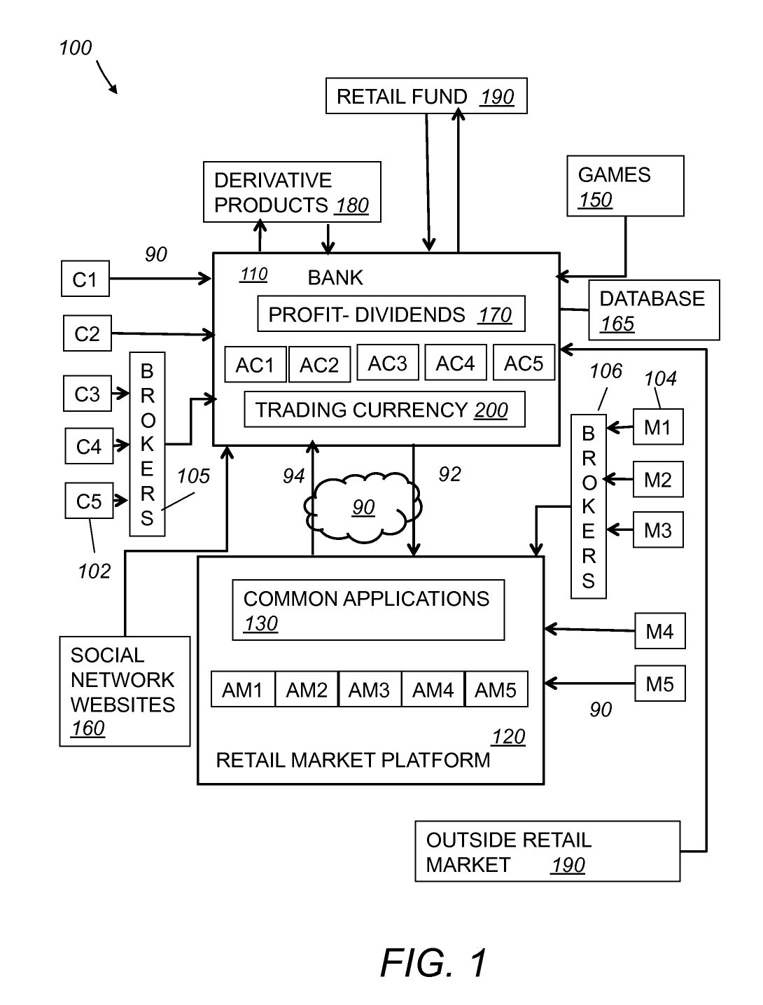

Referring to FIG. 1, a retail platform and investment system 100 is realized over a computer network 90 and includes a bank application 110 and a retail market platform 120. Bank application 110 issues a system currency or open market currency (OMC) 200 and creates and manages customer accounts 112 (AC1-AC5). Customers C1 and C2 access the bank application 110 directly over a network connection 90 and open accounts AC1 and AC2, respectively. Alternatively, customers C3-C5 contact brokers 105 and through them they open accounts AC3-AC5, respectively. Customers C1-C5 purchase funds in the open market currency 200 and deposit their funds in their corresponding accounts AC1-AC5. The exchange rate of the open market currency 200 to other currencies is determined by the bank application 110. Bank application 110 accesses the retail market platform 120 directly or via network 90. In one example, network 90 is the Internet. Retail market platform 120 includes individual merchant applications 140 (AM1-AM5) and common applications 130. Merchants M4 and M5 access the retail market platform 120 directly over a network connection 90 and generate individual merchant applications AM4 and AM5, respectively. Alternatively, merchants M1-M3 contact brokers 106 and through them they generate individual merchant applications AM1-AM3, respectively. Common applications 130 manage, aggregate, and promote the individual merchant applications AM1-AM5.

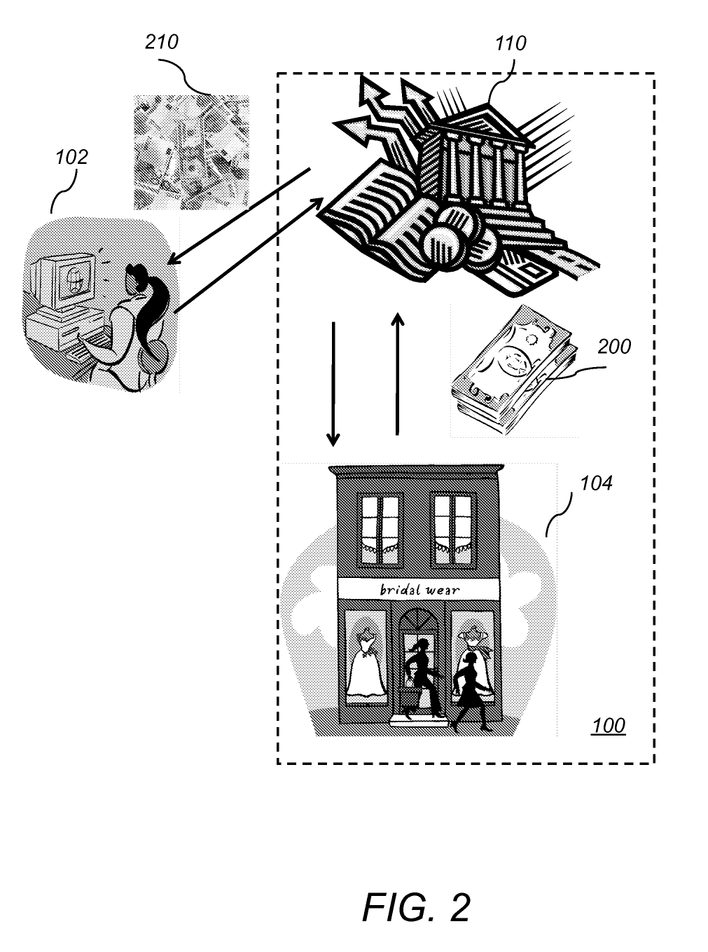

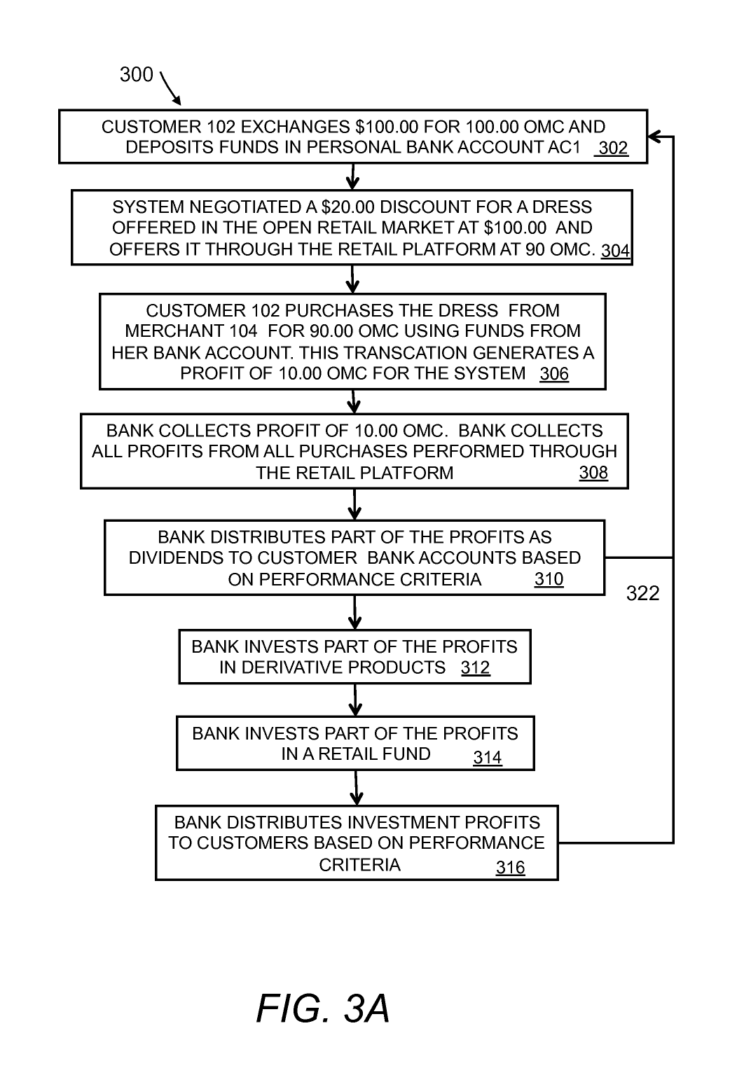

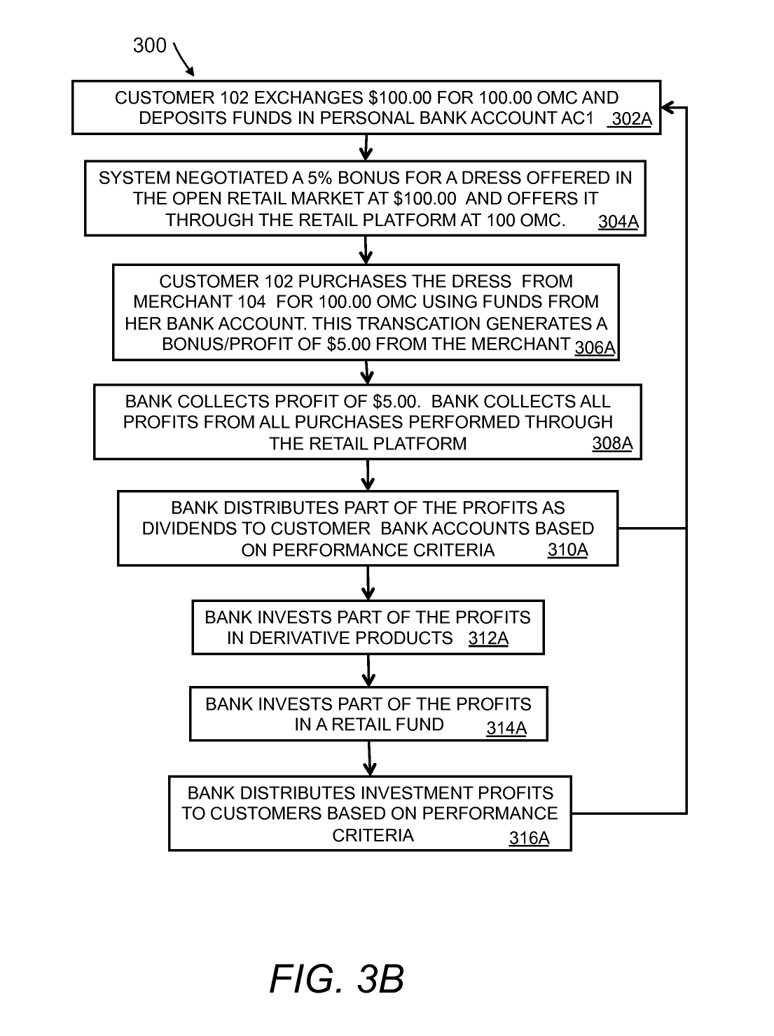

Referring to FIG. 2 and FIG. 3A, a customer 102 who has opened an account with the bank application 110 uses any type of currency 210 (Dollar, Euro, Lira, Yen, among others) to purchase funds in the system currency 200 and deposits the funds in her personal account (302). In one example, customer 102 exchanges $100.00 for 100.00 OMC. System 100 has negotiated an arrangement with merchant 104 to offer products through the system's retail platform 120 at a discounted price compared to the open retail market (304). In return for the discount, merchant 104 receives access to value-added services. These value added services are provided by the system, and include grouping of buyers, consumption planning and forecast, new market discovery, interest discovery, sales management, production planning, collaborative recommendations, and production recommendations, among others. Next, the customer 102 browses the individual merchant applications AM1-AM5 and chooses to purchase a dress from merchant 104 (304). Customer 102 pays for the dress with funds from her personal bank account. In one example, the dress is offered outside of the retail market platform 120 at $100.00. The system 100 has negotiated a specific discount with the merchant 104 for offering the dress through the retail market platform. Part of the discount is passed on the customer at the time of purchase and part is retained by the system. In the above mentioned example, the negotiated merchant discount is $20.00. The dress is then offered to customer 102 within the retail market platform 120 at the discounted price of 90.00 OMC. The system collects the 90.00 OMC from the customer, pays the merchant 80.00 OMC and retains 10.00 OMC as a profit for the system (306). This system profit is collected and retained by the bank. This process is repeated for all customers 102 that sign up into the bank application 110 and for all their purchases from merchants 104 listed with the retail market platform 120. The bank application 110 keeps track and stores data for all purchase transactions and system profits for all customers and all merchants operating within the retail market platform 120 (308). These data are stored in database 165. Next, the bank application 110 calculates and distributes dividends to customers 102 and other system participants based on performance metrics (310). Examples of performance metrics include number of purchases within a given period of time, time of membership on the system, number of referrals and acquisitions of new customers and/or new merchants, and percentage of investment and reinvestment of dividends, among others. The performance metrics are selected so that they promote growth in purchase transactions. Other system contributors that are eligible to collect dividends include brokers for customers 105, brokers for merchants 106, application developers, system designers and operating personnel of bank 110, among others. The bank application 110 also invests some of the profits in derivative products and services, including swaps, contracts, futures and options, among others (312). Some of the profits are invested in retail funds used to fund merchants and producers of the merchandise sold in the retail market platform (314). The profits from these investments are again distributed to the system 100, customers 102, brokers 105, 106, developers, designers, and operating personnel based on the above mentioned performance metrics (316).

In another embodiment, customer 102 purchases goods and services at the regular (undiscounted) retail price and the merchant 104 pays a bonus to the system 100. The bonuses are aggregated by the system and then distributed as dividends to system 100, customers 102, brokers 105, 106, developers, designers, and operating personnel. Referring to FIG. 3B, a customer 102 who has opened an account with the bank application 110 uses any type of currency 210 (Dollar, Euro, Lira, Yen, among others) to purchase funds in the system currency 200 and deposits the funds in her personal account (302a). In one example, customer 102 exchanges $100.00 for 100.00 OMC. System 100 has negotiated a bonus/commission arrangement with merchant 104 for offering and selling products through the system's retail platform 120 (304a). In return for paying a bonus/commission, merchant 104 receives access to value-added services. These value added services are provided by the system, and include grouping of buyers, consumption planning and forecast, new market discovery, interest discovery, sales management, production planning, collaborative recommendations, and production recommendations, among others. Next, the customer 102 browses the individual merchant applications AM1-AM5 and chooses to purchase a dress from merchant 104 (304a). Customer 102 pays for the dress with funds from her personal bank account. In one example, the dress is offered within the retail market platform 120 at the same price of $100.00 as it is offered outside of the retail market platform 120. The system 100 has negotiated a 5% bonus/commission with the merchant 104 for offering the dress through the retail market platform 120. The system collects 100.00 OMC from the customer, pays $100.00 to the merchant, and receives $5.00 bonus from the merchant. The $5.00 bonus is retained by the bank as a system profit (306a). This process is repeated for all customers 102 that sign up into the bank application 110 and for all their purchases from merchants 104 listed with the retail market platform 120. The bank application 110 keeps track and stores data for all purchase transactions and system profits for all customers and all merchants operating within the retail market platform 120 (308a). These data are stored in database 165. Next, the bank application 110 calculates and distributes dividends to customers 102 and other system participants based on performance metrics (310a). Examples of performance metrics include number of purchases within a given period of time, time of membership on the system, number of referrals and acquisitions of new customers and/or new merchants, and percentage of investment and reinvestment of dividends, among others. The performance metrics are selected so that they promote growth in purchase transactions. Other system contributors that are eligible to collect dividends include brokers for customers 105, brokers for merchants 106, application developers, system designers and operating personnel of bank 110, among others. The bank application 110 also invests some of the profits in derivative products and services, including swaps, contracts, futures and options, among others (312a). Some of the profits are invested in retail funds used to fund merchants and producers of the merchandise sold in the retail market platform (314a). The profits from these investments are again distributed to the system 100, customers 102, brokers 105, 106, developers, designers, and operating personnel based on the above mentioned performance metrics (316a).

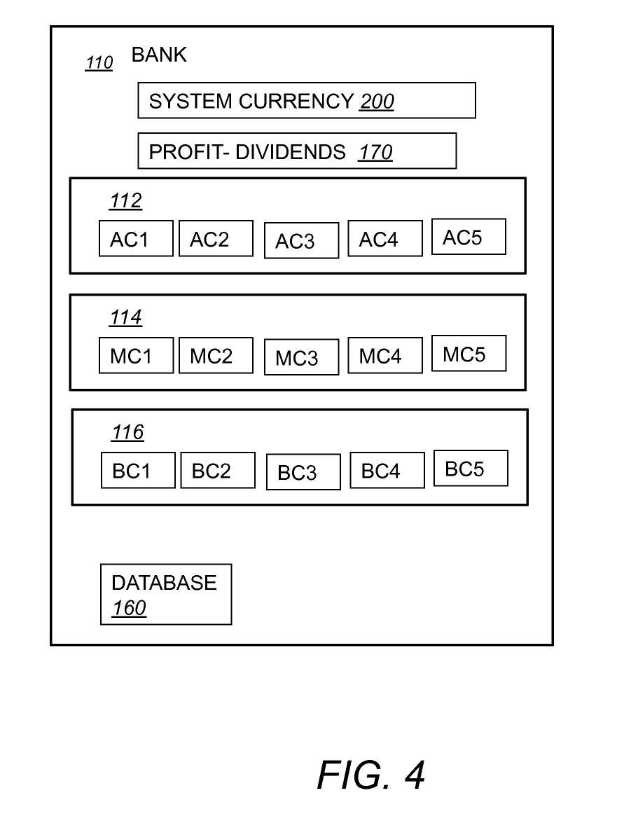

Referring to FIG. 4, bank application 110 opens and maintains all customer accounts 112 and keeps track of all purchases made by each customer and the corresponding discount profits. Bank application 110 also maintains records of all deposits, withdrawals, and transfers into and out of each account and records the financial interface (credit card, debit card, or ACH) used in these transactions. Bank application 110 also opens and keeps track of merchant accounts 114 for each individual merchant application 140 (AM1-AM5), of all merchant discounts offered through the system and of all the sales transacted and profits generated through the system for each merchant. Bank application 110 also opens and keeps track of broker accounts 116 (BC1-BC5) and of all the new customer and merchant acquisitions generated by each broker. Based on these records bank application 110 calculates the dividend, determines eligibility and distributes the calculated dividend to each eligible customer, broker, developer, designer, and operating personnel. Bank application 110 also calculates and distributes commissions to each broker 105, 106 based on new customer and merchant acquisitions generated by each broker. Bank application 110 also calculates the share of the profits from the investments in the derivative products 180 and retail funds 190 and distributes them to each eligible investor. Bank application 110 also issues loans to eligible customers, brokers, developers, designers, operating personnel and other system users.

All financial transactions within the system 100 use the system currency 200 (OMC). Transactions into and out of the system (i.e., deposits and withdrawals) convert the system currency into a selected currency, including Dollar, Euro, Lira, Yen, among others. The system currency may be converted at a fixed rate (for example at the Dollar rate) or may be dynamically converted in accordance with the currency exchange mechanism. In one example, the system currency is converted based on the foreign exchange market (Forex) mechanism. The system currency 200 is secured by the actual goods and services that are traded through the system, the delivery contracts, and the funds in the users accounts.

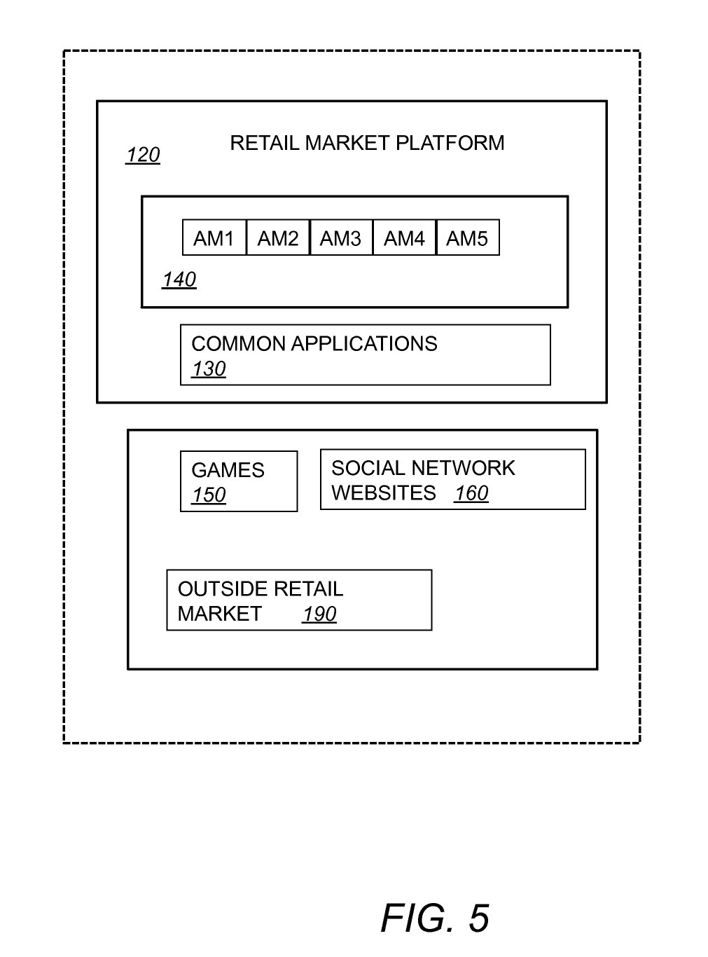

Referring to FIG. 5, retail market platform 120 is an aggregator of retail market applications. It includes individual merchant applications 140 and common applications 130. Individual merchant applications 140 (AM1-AM5) are used for the presentation of product offerings and the completion of the ordering, payment, product delivery and fulfillment. Platform 120 provides application programming interfaces (APIs) for the development of the individual merchant applications 140 and common applications 130. The APIs are used for the generation and management of merchant websites and product catalogs offered by each individual merchant application.

Common applications 130 manage, aggregate, and promote the individual merchant applications AM1-AM5. Examples of common applications include browsing, searching, advertising, grouping and comparing of product offerings and attributes, product reviews and recommendations, collaborative recommendations and suggestions, network marketing tools, and hot product presentation, among others. The system 100 also interacts with other systems outside of the retail application platform 120. These outside of the retail platform systems includes merchants that have not signed with the retail market platform 190 (outside retail market), game applications, and websites 150, social networking applications and websites 160, and other consuming online or offline businesses. The system 100 provides APIs for the development of applications that manage these interactions with outside systems.

The system 100 utilizes brokers 105 for promotion and generation of new customers. The system also utilizes brokers 106 for the promotion and registration of new merchants. Brokers 105 and 106 bring customers, merchants, other brokers, application developers and investors to the system 100. Brokers 105 and 106 also promote the products offered through the system, group customers, group merchants, build retail networks and assist in the planning and operation of the entire system 100.

Other embodiments of the system may include one or more of the following. The system users (customers, brokers, merchants, application developers, operation personnel, among others) invest some of their profits directly into specific merchants or producers of goods and services offered through the system. The system co-invests into specific merchants, producers of goods and services, brokers, applications and tool developers. These types of investments are based on market knowledge obtained from the statistical evaluation of all transactions performed through the system. The system users trade derivative products 180 and shares of the retail fund 190 among themselves. The system may be applied for business-to-business (B2B) transactions, business-to-consumers (B2C) transactions, consumer-to-consumer (C2C) transactions, stock market transactions, transactions within computer games or transactions within social networking websites and applications, among others.

In one embodiment, the invention provides a method for co-investing in merchants based on buyers' preferences. As was described above, the system 100 collects information on purchase statistics from many customers and merchants trading within the system. This purchase statistic information may also be collected from third party merchants and other sources outside of the system. Based on all the collected purchase statistic information the system decides what products or services to buy and offer and then buys in advance selected services and products. This results in receiving maximum discounts from merchants and service providers, offering various premium services to customers and generating profits.

In another embodiment, the invention provides a method for acquiring a subscription of services for a flat fee. The system collects information on purchase statistics from many buyers and merchants. This information may be collected from buyers and merchants trading within the system. Alternatively, this information may be collected from third party merchants and other sources. Based on the collected information, the system decides what products and services would be desirable to buy and offer to its customers. In one example, the system buys a whole volume of various services from one or more service providers at a flat price (a price for term volume) and then offers these services to its customers based on a flat fee subscription term. Examples of services include health services, legal services, financial services, and insurance services, among others. This results in receiving maximum discounts from service providers, offering various premium services to customers, and generating profits.

In another embodiment, the invention provides a method for providing global collaborative product recommendations to customers. The system collects information on purchase statistics from many buyers and merchants. This information may be collected from buyers and merchants trading within the system. Alternatively, this information may be collected from third party merchants and other sources. Based on the collected information, the system uses collaborative filtering technologies to provide recommendations to other customers on what products or services to buy that meet their needs in the best way. Based on collaborative filtering algorithms, the system builds consumer networks groups, provides for making collective purchases, and provides for developing common preferences, among others. This results in receiving maximum discounts from merchants and service providers, offering various premium services to customers, and generating profits.

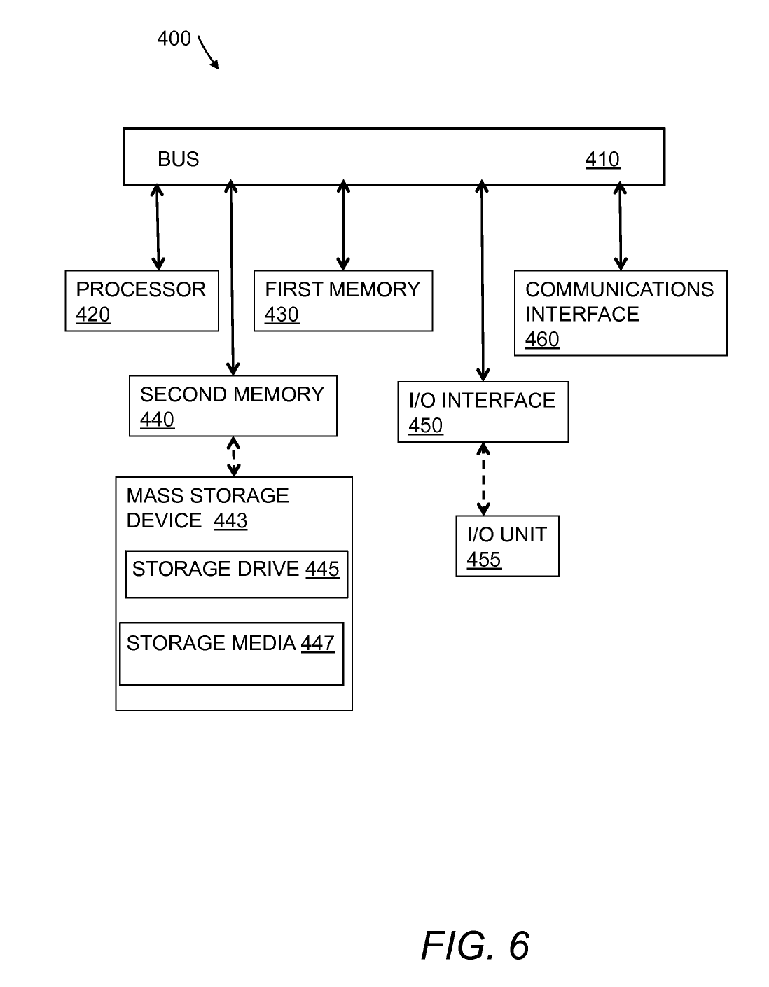

Referring to FIG. 6, an exemplary computer system 400 or network architecture that may be used to implement the system of the present invention includes a processor 420, first memory 430, second memory 440, I/O interface 450 and communications interface 460. All these computer components are connected via a bus 410. One or more processors 420 may be used. Processor 420 may be a special-purpose or a general-purpose processor. As shown in FIG. 6, bus 410 connects the processor 420 to various other components of the computer system 400. Bus 410 may also connect processor 420 to other components (not shown) such as, sensors, and servomechanisms. Bus 410 may also connect the processor 420 to other computer systems. Processor 420 can receive computer code via the bus 410. The term “computer code” includes applications, programs, instructions, signals and/or data, among others. Processor 420 executes the computer code and may further send the computer code via the bus 410 to other computer systems. One or more computer systems 400 may be used to carry out the computer executable instructions of this invention.

Computer system 400 may further include one or more memories, such as first memory 430 and second memory 440. First memory 430, second memory 440, or a combination thereof function as a computer usable storage medium to store and/or access computer code. The first memory 430 and second memory 440 may be random access memory (RAM), read-only memory (ROM), a mass storage device, or any combination thereof. As shown in FIG. 6, one embodiment of second memory 440 is a mass storage device 443. The mass storage device 443 includes storage drive 445 and storage media 447. Storage media 447 may or may not be removable from the storage drive 445. Mass storage devices 443 with storage media 447 that are removable, otherwise referred to as removable storage media, allow computer code to be transferred to and/or from the computer system 400. Mass storage device 443 may be a Compact Disc Read-Only Memory (“CDROM”), ZIP storage device, tape storage device, magnetic storage device, optical storage device, Micro-Electro-Mechanical Systems (“MEMS”), nanotechnological storage device, floppy storage device, hard disk device, USB drive, among others. Mass storage device 443 may also be program cartridges and cartridge interfaces, removable memory chips (such as an EPROM, or PROM) and associated sockets.

The computer system 400 may further include other means for computer code to be loaded into or removed from the computer system 400, such as the input/output (“I/O”) interface 450 and/or communications interface 460. Both the I/O interface 450 and the communications interface 460 allow computer code to be transferred between the computer system 400 and external devices including other computer systems. This transfer may be bi-directional or omni-direction to or from the computer system 400. Computer code transferred by the I/O interface 450 and the communications interface 460 are typically in the form of signals, which may be electronic, electromagnetic, optical, or other signals capable of being sent and/or received by the interfaces. These signals may be transmitted via a variety of modes including wire or cable, fiber optics, a phone line, a cellular phone link, infrared (“IR”), and radio frequency (“RF”) link, among others.

The I/O interface 450 may be any connection, wired or wireless, that allows the transfer of computer code. In one example, I/O interface 450 includes an analog or digital audio connection, digital video interface (“DVI”), video graphics adapter (“VGA”), musical instrument digital interface (“MIDI”), parallel connection, PS/2 connection, serial connection, universal serial bus connection (“USB”), IEEE1394 connection, PCMCIA slot and card, among others. In certain embodiments the I/O interface connects to an I/O unit 455 such as a user interface, monitor, speaker, printer, touch screen display, among others. Communications interface 460 may also be used to transfer computer code to computer system 400. Communication interfaces include a modem, network interface (such as an Ethernet card), wired or wireless systems (such as Wi-Fi, Bluetooth, and IR), local area networks, wide area networks, and intranets, among others.

The invention is also directed to computer products, otherwise referred to as computer program products, to provide software that includes computer code to the computer system 400. Processor 420 executes the computer code in order to implement the methods of the present invention. In one example, the methods according to the present invention may be implemented using software that includes the computer code that is loaded into the computer system 400 using a memory 430, 440 such as the mass storage drive 443, or through an I/O interface 450, communications interface 460, or any other interface with the computer system 400. The computer code in conjunction with the computer system 400 may perform any one of, or any combination of, the steps of any of the methods presented herein. The methods according to the present invention may be also performed automatically, or may be invoked by some form of manual intervention. The computer system 400, or network architecture, of FIG. 6 is provided only for purposes of illustration, such that the present invention is not limited to this specific embodiment.

Several embodiments of the present invention have been described. Nevertheless, it will be understood that various modifications may be made without departing from the spirit and scope of the invention. Accordingly, other embodiments are within the scope of the following claims.

What is claimed is:

1. An online retail and investment system comprising:
a computing system;
a bank application configured to run in said computing system and to be accessed via a network;
a retail market application configured to run in said computing system and to be accessed via said network;
an open market currency (OMC), wherein said OMC is issued by the bank application and is used for making payments for purchase transactions within the retail market application;
wherein customers access the bank application over a network connection and open bank accounts and subsequently the customers purchase funds in the open market currency and deposit the OMC funds in their corresponding bank accounts; and
wherein merchants access the retail market application via a network connection and open merchant accounts and subsequently offer their goods and services for sale to customers through the retail market application; and
wherein said customers purchase goods and services offered by the merchants through the retail market application and pay for the purchased goods and services with OMC funds from their corresponding bank accounts.

2. The system of claim 1, wherein the merchants offer their goods and services to the customer through the retail market application at a discount and wherein a first portion of the discount is passed to the customers at the time of the purchase transaction and a second portion of the discount is retained by the system as a profit.

3. The system of claim 1, wherein the merchants pay a bonus for selling their goods and services to the customer through the retail market application and wherein the bonus is retained by the system as a profit.

4. The system of claim 2, wherein said system profit is accumulated and is distributed as a dividend to said customers, outside system investors, and system participants.

5. The system of claim 4, wherein said system profit is distributed as a dividend based on performance metrics and wherein said performance metrics are configured to promote growth of the total volume of the purchase transactions and comprise one or more of number of purchases within a given period of time, length of system membership, number of new customer referrals, number of new customer acquisitions, number of new merchant acquisitions, number of fund shares, or percentage of reinvestment of dividend.

6. The system of claim 5, wherein said system participants comprise brokers for customers, brokers for merchants, application developers, system designers and operating bank personnel.

7. The system of claim 6, wherein said bank application is configured to maintain all customer data associated with the customer bank accounts and to keep track of all data associated with purchases made by each customer within the retail market application and the corresponding discount profits associated with these purchases and to maintain records for all deposits, withdrawals, transfers and wire transactions for each customer bank account.

8. The system of claim 7, wherein said bank application is configured to maintain all merchant data associated with the merchant accounts and to keep track of all merchant discounts, all sales transacted and all profits generated within the retail market application.

9. The system of claim 8, further comprising customer brokers and merchant brokers and wherein said customer brokers open customer account within said bank application and wherein said merchant brokers open merchant accounts in said retail market application and wherein said bank application further comprises broker accounts and is configured to maintain all broker data associated with the broker accounts and to keep track of all new customer accounts and new merchant accounts generated by each broker.

10. The system of claim 9, further comprising a database and wherein said database stores said customer data, said merchant data and said broker data.

11. The system of claim 10, wherein said bank application is configured to calculate the dividend, to determine eligibility and to distribute the calculated dividend to each eligible customer, broker, outside system investors, and system participants.

12. The system of claim 11, wherein said bank application is configured to issue loans to each eligible customer, broker, outside system investors, and system participants, based on the accumulated profits.

13. The system of claim 12, further comprising a retail market platform and wherein said retail market platform comprises said retail market application, individual merchant applications and common applications and wherein said individual merchant applications are configured to present product offerings for individual merchants and wherein said common applications are configured to manage, aggregate and promote the individual merchant applications.

14. The system of claim 13, wherein said common applications comprise one or more of browsing, searching, advertising, grouping, comparing of product offerings, product reviews and recommendations, collaborative recommendations and suggestions, network marketing tools or hot product presentation.

15. The system of claim 2 wherein said merchants receive value added services in return for the provided discount and wherein said value added services comprise one or more of grouping of buyers, consumption planning and forecast, new market discovery, sales management, production planning or collaborative recommendations.

16. A method for providing online retail and investment comprising:
providing a computing system;
providing a bank application configured to run in said computing system and to be accessed via a network;
providing a retail market application configured to run in said computing system and to be accessed via said network;
providing an open market currency (OMC), wherein said OMC is issued by the bank application and is used for making payments for purchase transactions within the retail market application;
wherein customers access the bank application over a network connection and open bank accounts and subsequently the customers purchase funds in the open market currency and deposit the OMC funds in their corresponding bank accounts; and
wherein merchants access the retail market application via a network connection and open merchant accounts and subsequently offer their goods and services for sale to customers through the retail market application; and
wherein said customers purchase goods and services offered by the merchants through the retail market application and pay for the purchased goods and services with OMC funds from their corresponding bank accounts.

17. The method of claim 16, wherein the merchants offer their goods and services to the customer through the retail market application at a discount and wherein a first portion of the discount is passed to the customers at the time of the purchase transaction and a second portion of the discount is retained as a profit.

18. The method of claim 16, wherein the merchants pay a bonus for selling their goods and services to the customer through the retail market application and wherein the bonus is retained by the system as a profit.

19. The method of claim 17, wherein said profit is accumulated and is distributed as a dividend to said customers, outside investors, brokers for customers, brokers for merchants, application developers, system designers and operating bank personnel.

20. The method of claim 18, wherein said profit is distributed as a dividend based on performance metrics and wherein said performance metrics are configured to promote growth of the total volume of the purchase transactions, and comprise one or more of number of purchases within a given period of time, length of membership, number of new customer referrals, number of new customer acquisitions, number of new merchant acquisitions, number of fund shares, or percentage of reinvestment of dividend.

21. The method of claim 20, wherein said bank application is configured to maintain all customer data associated with the customer bank accounts and to keep track of all data associated with purchases made by each customer within the retail market application and the corresponding discount profits associated with these purchases and to maintain records for all deposits, withdrawals, transfers and wire transactions for each customer bank account.

22. The method of claim 21, wherein said bank application is configured to maintain all merchant data associated with the merchant accounts and to keep track of all merchant discounts, all sales transacted and all profits generated within the retail market application.

23. The method of claim 22, further comprising providing customer brokers and merchant brokers and wherein said customer brokers open customer account within said bank application and wherein said merchant brokers open merchant accounts in said retail market application and wherein said bank application further comprises broker accounts and is configured to maintain all broker data associated with the broker accounts and to keep track of all new customer accounts and new merchant accounts generated by each broker.

24. The method of claim 23, further comprising providing a database and wherein said database stores said customer data, merchant data and broker data.

25. The method of claim 24, wherein said bank application is configured to calculate the dividend, to determine eligibility and to distribute the calculated dividend to each eligible customer, broker, outside system investors, and system participants.

26. The method of claim 25, wherein said bank application is configured to issue loans to each eligible customer, broker, outside system investors, and other participants, based on the accumulated profits.

27. The method of claim 26, further comprising providing a retail market platform and wherein said retail market platform comprises said retail market application, individual merchant applications and common applications and wherein said individual merchant applications are configured to present product offerings for individual merchants and wherein said common applications are configured to manage, aggregate and promote the individual merchant applications.

28. The method of claim 27, wherein said common applications comprise one or more of browsing, searching, advertising, grouping, comparing of product offerings, product reviews and recommendations, collaborative recommendations and suggestions, network marketing tools or hot product presentation.

29. The method of claim 17, wherein said merchants receive value added services in return for the provided discount and wherein said value added service comprise one or more of grouping of buyers, consumption planning and forecast, new market discovery, sales management, production planning or collaborative recommendations.
